(19) United States
(12) Patent Application Publication
(10) Pub. No.: US 2009/0017156 A1
(43) Pub. Date: Jan. 15, 2009

(54) CHOLESTROL REDUCING FOOD COMPOSITIONS FOR ANIMALS

(76) Inventor: Shiguang Yu, Topeka, KS (US)

Correspondence Address: COLGATE-PALMOLIVE COMPANY, 909 RIVER ROAD, PISCATAWAY, NJ, 08855, US

(21) Appl. No.: 11/774,932

(22) Filed: Jul. 9, 2007

(51) Int. Cl. A23K 1/16

(52) U.S. Cl. 426/2; 426/648

(57) ABSTRACT

Compositions and methods for reducing serum cholesterol levels in companion animals, such as cats and dogs, wherein the food compositions contain about 20% or more oat, and the methods comprise administering the food compositions effective to reduce serum cholesterol levels in the animals.

This invention relates to cholesterol reducing food compositions and methods for reducing serum cholesterol levels in animals. Specifically, this invention relates to food compositions containing approximately 20% dietary oat, which reduces serum cholesterol levels in animals.

### BACKGROUND OF THE INVENTION

Animals, particularly companion animals (e.g., dogs and cats), may develop hypercholesterolemia, an abnormal condition characterized by elevated serum cholesterol levels. Hypercholesterolemia may occur together with chronic renal failure, hypothyroidism, cholestasis, hyperadrenocorticoidism, diabetes mellitus, idiopathic hypercholesterolemia, lipoprotein lipase deficiency, and primary hyperchylomicronemia, for example. Accordingly, it is beneficial to be able to lower the serum cholesterol levels conveniently by administering a cholesterol reducing food composition as part of an animal's diet.

The following is a list of publications pertaining to oat or oat bran on serum lipid profiles or total cholesterol concentrations:
D. A. Kerckhoff et al., Am. J. Clin. Nutr., 78(2):221-227(2003);
K. Hermansen et al., Adv. Ther., 20(1):50-78(2003);
K. C. Maki et al, J. Nutr., 133(2):468-475(2003);
M. Andersson et al, Am. J. Clin. Nutr., 76(5):1111-1116(2002);
D. A. Kerckhoff et al., J. Nutr., 132(9):2494-22505(2002);
L. Van Horn et al., J. Am. Diet Assoc. 101(11): 1319-1325(2001);
E. Saltzman et al., J. Nutr., 131(5):1465-1470(2001);
J. A. Lovegrove et al., Am. J. Clin. Nutr., 72(1):49-55(2000);
G. Onning et al., Ann. Nutr. Metab. 43(5):301-309(1999);
H. Grajeta, Nahrung., 43(2):114-117(1999);
S. Bell et al., Crit. Rev. Food Sci. Nutr., 39(2):189-202(1999);
L. Brown et al., Am. J. Clin. Nutr., 69(1):30-42(1999);
A. L. Romero et al., J. Am. Coll. Nutr., 17(6):601-608(1998);
A. L. Gerhardt et al., J. Nutr., 128(5):601-608(1998);
M. I. Uusitupa et al., Eur. J. Clin. Nutr., 51(9):607-611(1997);
K. M. Behall et al., J. Am. Coll. Nutr., 16(1):46-51(1997);
J. Masse, Eur. J. Chin. Nutr., 50(4):274-275(1996);
E. Rytter et al., Ann. Nutr. Metab., 40(4):212-220(1996);
A. Lia et al., Am. J. Clin. Nutr., 62(6):1245-1251(1995);
M. U. Beer et al., Eur. J. Clin. Nutr., 49(7):517-522(1995);
I. Winblad et al., Scand. J Prim. Health Care, 13(2):118-121(1995);
C. Dubois et al., Am. J. Clin. Nutr., 61(2):325-333(1995);
J. A. Marlett et al., Hepatology, 20(6):1450-1457(1994);
M. J. Kelley et al., J. Am. Diet Assoc., 94(12):1419-1421(1994);
K. A. Jackson et al., J. Nutr., 124(9):1678-1684(1994);
R. W. Welch, Br. J. Biomed. Sci., 51(3):260-270(1994);
J. T. Braaten et al., Eur. J. Clin. Nutr., 48(7):465-474(1994);
J. X. Jiang et al., Br. J. Nutr., 71(6):861-8701994);
T. Oda et al., J. Nutr. Sci. Vitaminol. (Tokyo)., 40(2):213-217(1994);
N. Poulter et al., Am. J. Clin. Nutr., 59(1):66-69(1994);
K. A. Jackson et al., Br. J. Nutr., 70(1):211-219(1993);
T. Oda et al., J. Nutr. Sci. Vitaminol. (Tokyo)., 39(1):73-79(1993);
M. I. Uusitupa et al., J. Am. Coll. Nutr., 11(6):651-659(1992);
P. Bartram et al., JPEN J. Parenter. Enteral. Nutr., 16(1):46-51(1997);
T. L. Saudia et al., Mil. Med., 157(11):567-568(1992);
F. M. Stewart et al., N.Z. Med. J., 105(943):398-400(1992);
P. D. Roach et al., Atherosclerosis, 96(2-3):219-226(1992);
B. H. Arjmandi et al., J. Nutr., 122(7):1559-1565(1992);
De Groot et al., Lancet, ii:303-304(1963).

U.S. Pat. No. 4,175,124 describes methods of treating hypercholesterolemia. U.S. Pat. No. 5,545,414 describes a cholesterol lowering food product. U.S. Patent Publication No. 2006/0216394 describes a method and compositions to decrease serum cholesterol levels.

In recent years, companion animals such as cats and dogs are living longer lives as their medical and dietary needs are better served through increased research and awareness. As a result, attention has been directed to potential coronary disease issues arising from such long-lived animal's geriatric condition. Hypercholesterolemia is one example of a coronary disease that may develop in a geriatric animal. Accordingly, there is a need to lower the serum cholesterol levels of companion animals, such as cats and dogs, conveniently by administering a cholesterol-reducing food composition as part of the animal's diet.

While the use of dietary oat, such as oatmeal, in human diets as part of a diet to reduce serum cholesterol in people is known, cholesterol metabolism differs in dogs and cats compared to humans. For example, one report indicates that chicken, humans, rabbits, and trout display substantial cholesteryl ester transfer protein (CETP) activity, whereas CETP activity was not detectable in the cow, dog, horse, mouse, pig, and rat; and cats, goats, and sheep show deficient plasma cholesteryl ester transfer activity (V. Guyard-Dangremont et al., Comp. Biochem. Physiol. B. Biochem. Mol. Biol., 120(3):517-525(1998)). Further, the report found that chicken, pig, rabbit, and humans displayed significantly higher mean CETP activity but lower mean phospholipids transfer protein (PLTP) activity than cat, dog, mouse, and rat.

In a study of the relationship between plasma high-density lipoprotein cholesterol (HDL-C) concentrations and CETP activities in mouse, rat, dog, hamster, rabbit and monkey, it was reported that whereas the mouse, rat, and dog showed a high HDL-C/TC ration with low or absent CETP activity, the hamster, rabbit, and monkey displayed low HDL/TC ratio and high CETP activity (K. Tsutsumi et al., Biol. Pharm. Bull., 24(5):579-581(2001)). Thus, there are quite substantial differences in species cholesterol metabolism and it cannot be assumed a priori that the experiences from one species will transfer over to another species.

### BRIEF SUMMARY OF THE INVENTION

The present invention is directed to compositions and methods for reducing serum cholesterol in companion animals, such as cats and dogs, wherein the food compositions contain about 20% or more oat, and the methods comprise administering the food compositions effective to reduce serum cholesterol levels in the animals.

Additional or alternative advantages and benefits of the present invention will be apparent to one of skill in the art.

### BRIEF DESCRIPTION OF THE DRAWINGS

FIG. 1 is a plot of serum cholesterol levels in cats as a function of time for four different diet levels of dietary oat (0% oat, 6% oat, 10% oat, and 20% oat).

FIG. 2 is a bar graph of the change in serum cholesterol levels in cats for the four different diet levels of dietary oat—from left to right, 0% oat, 6% oat, 10% oat, and 20% oat after 12 weeks.

FIG. 3 is a plot of the serum cholesterol levels in dogs as a function of time for four different diet levels of dietary oat (0% oat, 5% oat, 10% oat, and 20% oat).

FIG. 4 is a bar graph of the change in serum cholesterol levels in dogs for the four different diet levels of dietary oat—from left to right, 0% oat, 5% oat, 10% oat, and 20% oat after 12 weeks.

### DETAILED DESCRIPTION OF THE INVENTION

It is contemplated that the invention described herein is not limited to the particular methodology, protocols, and reagents described as these may vary. It is also to be understood that the terminology used herein is for the purpose of describing particular embodiments only, and is not intended to limit the scope of the present invention in any way.

In one aspect, the present invention is directed to a method to reduce serum total cholesterol levels in a companion animal in need of such reduction comprising feeding the companion animal a diet comprising about 20% or more oat. In an embodiment, the diet is a serum cholesterol lowering diet.

In an embodiment of the aspect, the present invention is directed to a method to reduce serum total cholesterol levels in a companion animal in need of such reduction comprising feeding the companion animal a serum cholesterol lowering diet comprising about 20% or more oat, wherein the companion animal is a cat or a dog.

In another embodiment, the present invention is directed to a method to reduce serum total cholesterol levels in a companion animal in need of such reduction comprising feeding the companion animal a serum cholesterol lowering diet comprising about 20% or more oat, wherein the oat is whole oat, oat bran, oat flour, rolled oat flakes, instant oat flakes, steel cut oat groats, whole oat groats, or oat starch.

In yet another embodiment, the present invention is directed to a method to reduce serum total cholesterol levels in a companion animal in need of such reduction comprising feeding the companion animal a serum cholesterol lowering diet comprising about 20% or more oat, wherein the diet is maintained for 6 weeks or more.

In another embodiment, the present invention is directed to a method to reduce serum total cholesterol levels in a companion animal in need of such reduction comprising feeding the companion animal a serum cholesterol lowering diet comprising about 20% or more oat, wherein the diet is maintained for 8 weeks or more.

In still another embodiment, the present invention is directed to a method to reduce serum total cholesterol levels in a companion animal in need of such reduction comprising feeding the companion animal a serum cholesterol lowering diet comprising about 20% or more oat, wherein the diet is maintained for 12 weeks or more.

In an aspect, the present invention is directed to an animal food composition comprising about 20% or more oat effective to reduce the serum total cholesterol level in a companion animal in need of such reduction.

In an embodiment of this aspect, the present invention is directed to an animal food composition comprising about 20% or more oat effective to reduce the serum total cholesterol level in a companion animal in need of such reduction, wherein the companion animal is a cat or dog.

In an embodiment of this aspect, the present invention is directed to an animal food composition comprising about 20% or more oat effective to reduce the serum total cholesterol level in a companion animal in need of such reduction, wherein the animal food composition is a companion animal food composition.

In an embodiment of this aspect, the oat is whole oat, oat bran, oat flour, rolled oat flakes, instant oat flakes, steel cut oat groats, whole oat groats, or oat starch.

Unless defined otherwise, all technical and scientific terms used herein have the same meanings as commonly understood by one of ordinary skill in the art to which this invention belongs. As used herein, ranges are a shorthand for describing each and every value within a range, including endpoints. All references cited in the present disclosure are hereby incorporated by reference in their entirety. However, where there is a conflict between a definition in the present disclosure and that of a cited reference, the present disclosure controls.

As used herein and in the appended claims, the singular forms “a”, “an”, and “the” include plural reference unless the context clearly dictates otherwise.

As used herein, “an amount effective”. “an effective amount”, and like terms refer to that amount of a compound, material or composition as described herein that may be effective to achieve a particular biological result. Such effective activity may be achieved, for example, by administration of compositions of the present invention to an animal. An effective amount may be based on several factors, including an animal's ideal weight, the metabolizable energy of the composition, and frequency of feeding the animal compositions of the present invention, e.g., once, twice, or three times daily, and other compositions fed to the animal.

The present invention relates to any animal, preferably a mammal, more preferably a companion animal. The term “companion animal” refers to any animal that lives in close association with humans and includes, but is not limited to, canines and felines of any breed. For example, it is contemplated herein that this term may also encompass any animal whose diet may be controlled by humans and which may benefit from feeding the formulations disclosed herein. These animals may include, for example, domesticated farm animals (e.g. cattle, horses, swine, etc.) as well as undomesticated animals held in captivity, e.g. in zoological parks and the like. Preferably, companion animals are cats and dogs, preferably dogs.

All percentages expressed herein are on a weight by dry matter basis unless specifically stated otherwise.

As used herein, the term “about” as in “about 10%” refers to the value and a range around the specific number of plus/minus 1/20 of the number. Thus, “about 10%” refers to 9.95% to 10.05%. Similarly, “about 20%” refers to 19% to 21%.

As used herein, the term “oat” refers to ingredients or products made from whole oat and includes, for example, whole oat, oat bran, oat flour, rolled oat flakes, instant oat flakes, steel cut oat groats, whole oat groats, or oat starch, or mixtures thereof.

As used herein, the term “diet” refers to a substantially continual consumption of food over a period of time. A “serum cholesterol lowering diet” refers to a substantially continual consumption of food, over a period of time, sufficient to show a lowering of serum cholesterol levels.

As contemplated herein, the compositions of the present invention are meant to encompass nutritionally complete and balanced pet food compositions. Nutritionally complete and balanced pet food compositions are familiar to one of skill in the art. For example, nutrients and ingredients such as those disclosed herein as well as others suitable for animal feed compositions, and recommended amounts thereof, may be found, for example, in the Official Publication of the Associate of American Feed Control Officials, Inc. (“AAFCO”), Nutrient Requirements of Dogs and Cats, 2006.

Protein may be supplied by any of a variety of sources known by those skilled in the art, including plant sources, animal sources, or both. Animal sources include, for example, meat, meat by-products, seafood, dairy, eggs, etc. Meats include, for example, the flesh of poultry, fish, and mammals (e.g., cattle, pigs, sheep, goats, and the like). Meat by-products include, for example, lungs, kidneys, brain, livers, and stomachs and intestines (freed of all or essentially all their contents). The protein can be intact, almost completely hydrolyzed, or partially hydrolyzed. Protein content of foods may be determined by any number of methods known by those of skill in the art, for example, as published by the Association of Official Analytical Chemists in Official Methods of Analysis (“OMA”). The amount of “crude protein” in a composition disclosed herein may be determined based on the amount of nitrogen in the composition according to methods familiar to one of skill in the art.

Fat can be supplied by any of a variety of sources known by those skilled in the art, including meat, meat by-products, fish oil, and plants. Plant fat sources include wheat, flaxseed, rye, barley, rice, sorghum, corn, oats, millet, wheat germ, corn germ, soybeans, peanuts, and cottonseed, as well as oils derived from these and other plant fat sources. Fat content of foods may be determined by any number of methods known by those of skill in the art, such as published by OMA.

Carbohydrate may be supplied by any of a variety of sources known by those skilled in the art, including oat fiber, cellulose, peanut hulls, beet pulp, parboiled lice, corn starch, corn gluten meal, and any combination of those sources. Grains supplying carbohydrate include, but are not limited to, wheat, corn, barley, and rice. Carbohydrate content of foods may be determined by any number of methods known by those of skill in the art. Generally, carbohydrate percentage may be calculated as nitrogen free extract (“NFE”), which may be calculated as follows: NFE=100%−moisture %−protein %−fat %−ash %−crude fiber %.

Dietary fiber refers to components of a plant that are resistant to digestion by an animal's digestive enzymes. Dietary fiber components of foods may be determined by any number of methods known by those of skill in the art, such as published by OMA. Dietary fiber includes soluble and insoluble fibers.

Soluble fiber are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fiber may be supplied by any of a variety of sources, including cellulose, whole wheat products, wheat oat, corn bran, flax seed, grapes, celery, green beans, cauliflower, potato skins, fruit skins, vegetable skins, peanut hulls, and soy fiber. Soluble and insoluble fiber content of foods may be determined by any number of methods known by those of skill in the art, such as published by OMA.

Crude fiber includes indigestible components contained in cell walls and cell contents of plants such as grains, e.g., hulls of grains such as rice, corn, and beans. Crude fiber content of foods may be determined by any number of methods known by those of skill in the art, such as published by OMA.

The amino acid percentage of the compositions in the present invention may be determined by any means known in the art. For example, the values for the total amount of lysine provided by the invention can be determined using methods known in the art, as published by OMA. As another example, tryptophan content may be determined according to OMA method 988.15; methionine, cysteine and other amino acid content may be determined as published by OMA. Amino acid content may also be determined as published by OMA. The essential amino acids in the present compositions may be supplied by any number of sources, including crude protein, or addition of free amino acids to the composition.

Metabolizable energy (ME) of a diet is the energy available to an animal upon consumption of the diet after subtracting the energy excreted in feces, urine, and combustible gases. Metabolizable energy values may be determined by methods known by those skilled in the art as published by OMA.

“Ash” consists of compounds that are not organic or water, generally produced by combustion of biological materials. Ash may be determined by any number of methods known by those of skill in the art, such as published by OMA.

Carnitine, or L-carnitine, is a vitamin-like compound synthesized in the body from lysine and methionine. Carnitine may be naturally present in ingredients of the of the present invention, or carnitine may be added to the compositions. Methods of measuring carnitine are known in the art, such as described in R. Parvin and S. V. Pande, “Microdetermination of (−) Carnitine and Carnitine Acetyltransferases Activity,” ANALYTICAL BIOCHEMISTRY, vol. 79, pp. 190-201 (1977).

The compositions of the present invention also may contain one or more minerals and/or trace elements, e.g., calcium, phosphorus, sodium, potassium, magnesium, manganese, copper, zinc, or iron salts. One preferred trace element is manganese. Manganese is essential to a host of enzymes as a cofactor, which may regulate the metabolism of foods, including proteins, fats, and carbohydrates. Such enzymes may include oxidoreductases, transferases, hydrolases, lyases, isomerases, ligases, lectins, and integrins. Manganese also affects bone development and neurological function. Manganese may be naturally present in the components of the compositions, or it may be added to compositions. Methods of measuring manganese content in a composition are well known to those of skill in the art, such as published by OMA.

The compositions of the present invention may also include vitamins and minerals in amounts required to avoid deficiency and maintain health. These amounts, and methods of measurement are known by those skilled in the art. For example, AA-FCO provides recommended amounts of such ingredients for dogs and cats. As contemplated herein, useful vitamins may include, but are not limited to, vitamin A, vitamin B₁, vitamin B₂, vitamin B₆, vitamin B₁₂, vitamin C, vitamin D, vitamin E, vitamin H (biotin), vitamin K, folic acid, inositol, niacin, and pantothenic acid. The compositions of the present invention may additionally comprise additives, stabilizers, fillers, thickeners, flavorants, palatability enhancers and colorants in amounts and combinations familiar to one of skill in the art.

In one embodiment, the compositions are in the form of a food or pet food. In another embodiment, the composition is a treat. Treats are known to those skilled in the art, and can include, for example, compositions that are given to an animal to eat during non-meal time, e.g., a dog biscuit.

While foods of any consistency or moisture content are contemplated, preferably the compositions of the present invention may be, for example, a wet or dry animal food composition. “Wet” food refers to food that has a moisture content of about 70 to about a 90%. “Dry” food refers to compositions with about 5 to about 15% moisture content and is often manufactured in the form of small bits or kibbles. “Semi-moist” food refers to compositions with about 25 to about 45% moisture content. Also contemplated herein are compositions that may comprise components of various consistency as well as components that may include more than one consistency, for example, soft, chewy meat-like particles as well as kibble having an outer cereal component and an inner cream component as described in, e.g., U.S. Pat. No. 6,517,877.

### EXAMPLE 1

The effect of oat (oat groat) on serum cholesterol, blood pressure, oxidative status, and nitrogen metabolism was studied. Healthy adult cats (male and female American Domestic Short Hair over 1 year old) are fed the basal food which is nutritionally complete and balanced for 4 weeks before they are divided into 4 dietary groups, 12 cats in each group. At the end of this period (day 28 of the study), cats are stratified into 4 groups, 12 cats in each group, based on their age, body weight, and sex so that these parameters are similarly distributed among groups. Four experimental foods, with various concentrations of oat (oat groat: 0, 6, 10 and 20%) in the dry cat food—nutritionally complete and balance for maintenance, at the expense of rice and poultry meal in the food so that proximate analysis is similar among the foods—are randomly assigned to each group and fed to cats for an additional 8 weeks. Daily amounts of food are provided to each cat such to maintain its body weight (±10% of its initial body weight). Fresh tap water is always available to cats. Blood CBC, serum chemistry panel, blood pressure, and some biomarkers for oxidative stress in the serum or red blood cells are measured on day 28, 42, 56, and 84 of the study. Daily complete 24-hour urine and feces collection is made during week 12 (the last week of the study) to measure nitrogen dynamic in cats. Standard animal care procedures are followed during the study period.

The blood chemistry data from the study are shown below in Tables 1-4 for study weeks 4, 6, 8, and 12, respectively.

TABLE 1

| Study time | Week 4 | | | |
|---|---|---|---|---|
| Oat conc., % | 0 | 6 | 10 | 20 |
| Triglycerides, | 43.18 | 28.58 | 35.08 | 29 |
| mg/dl | | | | |
| Cholesterol, | 232.09 | 203.33 | 214.17 | 222.58 |
| mg/dl | | | | |
| BUN, mg/dl | 20 | 19 | 20 | 21 |
| Ammonia, | 174 | 171 | 186 | 144 |
| mg/dl | | | | |
| Creatinine, | 1.21 | 1.15 | 1.23 | 1.28 |
| mg/dl | | | | |
| Glucose, mg/dl | 81.18 | 85.25 | 85.75 | 82.83 |
| Sodium, mmol/l | 154.12 | 153.11 | 153.56 | 152.67 |
| Potassium, | 5.1 | 4.9 | 5.2 | 5.0 |
| mmol/l | | | | |
| Chloride, | 121.12 | 121.56 | 120.78 | 121.11 |
| mmol/l | | | | |
| Calcium, mg/dl | 10.6 | 10.4 | 10.6 | 10.4 |
| Phosphorus, | 4.9 | 4.6 | 4.6 | 4.4 |
| mg/dl | | | | |
| Magnesium, | 1.74 | 1.65 | 1.68 | 1.67 |
| mEq/l | | | | |
| Total protein, | 7.4 | 7.1 | 7.6 | 7.2 |
| g/dl | | | | |
| Albumin, g/dl | 3.5 | 3.3 | 3.3 | 3.3 |
| Globulin, g/dl | 4.0 | 3.8 | 4.3 | 3.9 |
| ALT, u/l | 57.18 | 57.5 | 62.17 | 62.58 |
| ALP, u/l | 40.55 | 37.92 | 47.17 | 36.5 |
| Total bilirubin, | 0.15 | 0.12 | 0.14 | 0.16 |
| mg/dl | | | | |

TABLE 2

| Study time | Week 6 | | | |
|---|---|---|---|---|
| Oat conc., % | 0 | 6 | 10 | 20 |
| Triglycerides, | 32.36 | 30.08 | 31.17 | 24.83 |
| mg/dl | | | | |
| Cholesterol, | 242.36 | 210.33 | 218 | 184.58 |
| mg/dl | | | | |
| BUN, mg/dl | 20 | 20 | 20 | 20 |
| Ammonia, | 122 | 105 | 100 | 102 |
| mg/dl | | | | |
| Creatinine, | 1.24 | 1.17 | 1.16 | 1.23 |
| mg/dl | | | | |
| Glucose, mg/dl | 88.91 | 78.08 | 90.92 | 83.33 |
| Sodium, mmol/l | 149.5 | 149.67 | 148.56 | 149 |
| Potassium, | 5.2 | 5.3 | 5.1 | 5.0 |
| mmol/l | | | | |
| Chloride, | 117.5 | 117.78 | 116.67 | 118.11 |
| mmol/l | | | | |
| Calcium, mg/dl | 10.3 | 10.2 | 10.1 | 10.1 |
| Phosphorus, | 4.7 | 4.9 | 4.7 | 4.4 |
| mg/dl | | | | |
| Magnesium, | 1.67 | 1.63 | 1.72 | 1.66 |
| mEq/l | | | | |
| Total protein, | 7.4 | 7.2 | 7.5 | 7.2 |
| g/dl | | | | |
| Albumin, g/dl | 3.3 | 3.3 | 3.2 | 3.3 |
| Globulin, g/dl | 4.1 | 3.9 | 4.3 | 4.0 |
| ALT, u/l | 57.73 | 53.67 | 54.33 | 54.83 |
| ALP, u/l | 37.45 | 38.92 | 43.5 | 34.25 |
| Total bilirubin, | 0.10 | 0.12 | 0.13 | 0.10 |
| mg/dl | | | | |

TABLE 3

| Study time | Week 8 | | | |
|---|---|---|---|---|
| Oat conc., % | 0 | 6 | 10 | 20 |
| Triglycerides, | 34.82 | 28.42 | 42.5 | 23.25 |
| mg/dl | | | | |
| Cholesterol, | 238.55 | 202 | 211.33 | 174.33 |
| mg/dl | | | | |
| BUN, mg/dl | 19 | 18 | 20 | 19 |
| Ammonia, | 148 | 126 | 116 | 105 |
| mg/dl | | | | |
| Creatinine, | 1.25 | 1.13 | 1.18 | 1.22 |
| mg/dl | | | | |
| Glucose, mg/dl | 82.27 | 81.83 | 82.33 | 79.33 |
| Sodium, mmol/l | 146.55 | 147.08 | 147.08 | 147.25 |
| Potassium, | 5.3 | 5.0 | 5.0 | 5.1 |
| mmol/l | | | | |
| Chloride, | 113.12 | 114.17 | 113.42 | 115.17 |
| mmol/l | | | | |
| Calcium, mg/dl | 10.4 | 10.3 | 10.4 | 10.2 |
| Phosphorus, | 4.9 | 4.7 | 4.8 | 4.6 |
| mg/dl | | | | |
| Magnesium, | 1.71 | 1.68 | 1.63 | 1.68 |
| mEq/l | | | | |
| Total protein, | 7.2 | 7.0 | 7.2 | 7.0 |
| g/dl | | | | |
| Albumin, g/dl | 3.2 | 3.2 | 3.1 | 3.1 |
| Globulin, g/dl | 3.9 | 3.8 | 4.1 | 3.9 |
| ALT, u/l | 54.09 | 51 | 55.25 | 56.08 |
| ALP, u/l | 34.91 | 39.83 | 45.75 | 33.17 |
| Total bilirubin, | 0.12 | 0.10 | 0.13 | 0.13 |
| mg/dl | | | | |

TABLE 4

| Study time | Week 12 | | | |
|---|---|---|---|---|
| Oat conc., % | 0 | 6 | 10 | 20 |
| Triglycerides, | 32.36 | 26.64 | 31.58 | 28.17 |
| mg/dl | | | | |
| Cholesterol, | 205.73 | 189.09 | 192 | 155.17 |
| mg/dl | | | | |
| BUN, mg/dl | 19 | 19 | 19 | 19 |
| Ammonia, | 158 | 147 | 152 | 123 |
| mg/dl | | | | |
| Creatinine, | 1.11 | 1.10 | 1.08 | 1.08 |
| mg/dl | | | | |
| Glucose, mg/dl | 76 | 83.73 | 77.08 | 76.08 |
| Sodium, mmol/l | 146.64 | 146.55 | 146.08 | 146.83 |
| Potassium, | 4.6 | 4.5 | 4.4 | 4.5 |
| mmol/l | | | | |
| Chloride, | 115.45 | 114.27 | 114.33 | 115.67 |
| mmol/l | | | | |
| Calcium, mg/dl | 9.9 | 9.9 | 9.9 | 9.9 |
| Phosphorus, | 5.0 | 5.3 | 4.7 | 4.8 |
| mg/dl | | | | |
| Magnesium, | 1.33 | 1.35 | 1.29 | 1.31 |
| mEq/l | | | | |
| Total protein, | 7.1 | 7.1 | 7.3 | 7.1 |
| g/dl | | | | |
| Albumin, g/dl | 3.2 | 3.2 | 3.2 | 3.2 |
| Globulin, g/dl | 3.9 | 3.9 | 4.2 | 4.0 |
| ALT, u/l | 61.91 | 57.55 | 58.42 | 61.17 |
| ALP, u/l | 29.36 | 34.91 | 39 | 30.25 |
| Total bilirubin, | 0.15 | 0.17 | 0.18 | 0.21 |
| mg/dl | | | | |

The results indicate that dietary oat as high as 20% does not affect blood pressure, oxidative status (plasma ORAC, glutathiones in WBC, glutathione peroxidase activities in serum and red blood cells, serum 8-OHdG and MDA), and nitrogen dynamics in healthy adult cats. No abnormality is observed during the study. Dietary oat at 20% significantly reduces serum total cholesterol by more than 30%. Dietary oat at 6% and 10% does not affect serum total cholesterol.

Food intake and body weight are similar among the four dietary groups during the study. Fecal score is also similar among groups, demonstrating that oat groat as high as 20% does not affect fecal quality. Oat does not affect heart rate and blood pressure. (Data not shown).

Oxidative stress is measured according to four aspects: antioxidant capacity (plasma ORAC, WBC glutathiones), antioxidant enzymes (red blood cell (RBC) and serum glutathione peroxidase), DNA damage (serum 8-OHdG), and fat oxidation (serum MDA). Oat has no practical meaningful effect on any of these measurements during the study. Plasma whole ORAC is consistently lower in cats fed 20% oat, including the initial time point when cats are not fed the food containing 20% oat.

Similarly, oat has no effect on hematological measurements in the cats. Further, urine nitrogen excretion tended to decrease in cats fed 20% oat but the decrease is not significant. Fecal nitrogen excretion is almost identical among the dietary groups. All cats have a positive nitrogen balance. Most nitrogen is excreted in the urine. Urinary nitrogen excretion makes up about 80% nitrogen intake. Oat as high as 20% in diet does not alter the nitrogen dynamics in the cats.

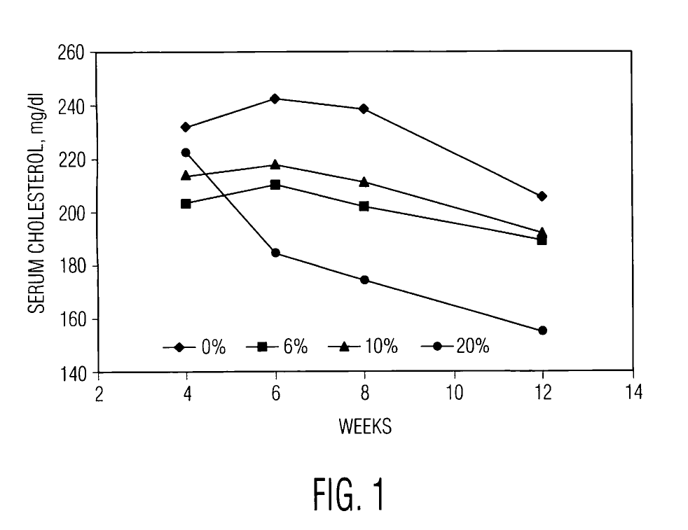

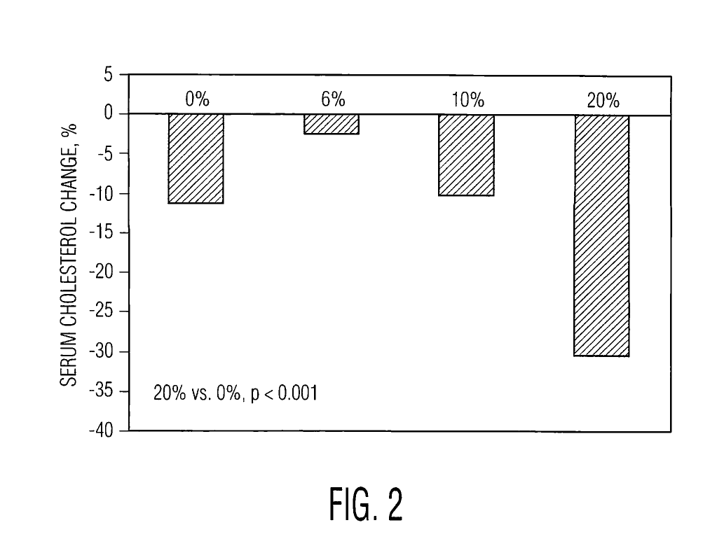

Referring to Tables 1-4, above, the results show that oat at 20% in a dry cat food significantly reduces serum total cholesterol in healthy adult cats. Serum total cholesterol concentration declined steadily in cats fed the diet containing 20% oat (FIG. 1). When comparing the initial serum cholesterol, dietary oat at 20% reduces serum total cholesterol by more than 30% (p<0.001, FIG. 2). Oat at 10% or 6% does not affect serum total cholesterol levels (FIG. 2).

### EXAMPLE 2

Forty-eight health adult beagles (>1 year) are given a nutritionally complete and balanced food for 4 weeks. At the end of this period (day 28 of the study), dogs are stratified into 4 groups, 12 dogs in each group, based on their age, body weight, and sex so that these parameters are similarly distributed among groups. Four experimental foods with various concentrations of oat (oat groat: 0, 5, 10 and 20%) in the dry dog food are randomly assigned to each group and fed to dogs for an additional 8 weeks. Oat groat is added at the expense of brewer's rice and yellow corn in the basal food. The proximate analysis of the experimental foods is similar. The daily amount of food provided to each dog is such as to maintain its body weight (±10% of its initial body weight). Fresh tap water is always available to the dogs. Blood CBC, serum chemistry panel, blood pressure, and some biomarkers for oxidative stress in the serum or red blood cells are measured on day 28, 42, 56, and 84 of the study. Daily complete 24-hour urine and feces collection is made during week 12 (the last week of the study) to measure nitrogen dynamic in dogs. Hill's standard animal care procedures are followed during the study period.

The blood chemistry data from the study are shown below in Tables 5-8 for study weeks 4, 6, 8, and 12, respectively.

TABLE 5

| Study time | Week 4 | | | |
|---|---|---|---|---|
| Oat conc. % | 0 | 5 | 10 | 20 |
| Triglycerides, | 85 | 101 | 135 | 82 |
| mg/dl | | | | |
| Cholesterol, | 247 | 241 | 264 | 261 |
| mg/dl | | | | |
| BUN, mg/dl | 14.6 | 14.2 | 14.0 | 14.3 |
| Ammonia, | 182 | 161 | 159 | 162 |
| mg/dl | | | | |
| Creatinine, | 0.60 | 0.57 | 0.53 | 0.55 |
| mg/dl | | | | |
| Glucose, mg/dl | 78 | 86 | 74 | 79 |
| Sodium, mmol/l | 163 | 157 | 158 | 156 |
| Potassium, | 4.7 | 4.6 | 5.0 | 4.7 |
| mmol/l | | | | |
| Chloride, | 123 | 119 | 119 | 119 |
| mmol/l | | | | |
| Calcium, mg/dl | 10.4 | 10.3 | 10.1 | 10.1 |
| Phosphorus, | 4.0 | 3.8 | 4.2 | 3.9 |
| mg/dl | | | | |
| Magnesium, | 1.8 | 1.8 | 1.8 | 1.7 |
| mEq/l | | | | |
| Total protein, | 6.5 | 6.2 | 6.3 | 6.3 |
| g/dl | | | | |
| Albumin, g/dl | 3.7 | 3.6 | 3.5 | 3.5 |
| Globulin, g/dl | 2.7 | 2.6 | 2.9 | 2.8 |
| ALT, u/l | 51 | 48 | 47 | 62 |
| ALP, u/l | 133 | 142 | 257 | 252 |
| Total bilirubin, | 0.4 | 0.5 | 0.8 | 0.4 |
| mg/dl | | | | |

TABLE 6

| Study time | Week 6 | | | |
|---|---|---|---|---|
| Oat conc. % | 0 | 5 | 10 | 20 |
| Triglycerides, | 86 | 88 | 92 | 90 |
| mg/dl | | | | |
| Cholesterol, | 242 | 236 | 253 | 249 |
| mg/dl | | | | |
| BUN, mg/dl | 14.6 | 15.0 | 13.4 | 15.6 |
| Ammonia | 149 | 119 | 137 | 147 |
| mg/dl | | | | |
| Creatinine, | 0.53 | 0.53 | 0.53 | 0.56 |
| mg/dl | | | | |
| Glucose, mg/dl | 74 | 84 | 73 | 77 |
| Sodium, mmol/l | 157 | 155 | 155 | 159 |
| Potassium, | 4.6 | 4.7 | 4.9 | 4.9 |
| mmol/l | | | | |
| Chloride, | 118 | 118 | 116 | 120 |
| mmol/l | | | | |
| Calcium, mg/dl | 10.2 | 10.3 | 10.0 | 10.5 |
| Phosphorus, | 4.1 | 4.0 | 4.1 | 4.4 |
| mg/dl | | | | |
| Magnesium, | 1.7 | 1.7 | 1.7 | 1.8 |
| mEq/l | | | | |
| Total protein, | 6.2 | 6.1 | 6.2 | 6.4 |
| g/dl | | | | |
| Albumin, g/dl | 3.6 | 3.5 | 3.4 | 3.5 |
| Globulin, g/dl | 2.6 | 2.6 | 2.8 | 2.9 |
| ALT, u/l | 47 | 55 | 51 | 59 |
| ALP, u/l | 135 | 154 | 278 | 203 |
| Total bilirubin, | 0.4 | 0.5 | 0.5 | 0.4 |
| mg/dl | | | | |

TABLE 7

| Study time | Week 8 | | | |
|---|---|---|---|---|
| Oat conc. % | 0 | 5 | 10 | 20 |
| Triglycerides, | 63 | 93 | 106 | 68 |
| mg/dl | | | | |
| Cholesterol, | 236 | 245 | 259 | 236 |
| mg/dl | | | | |
| BUN, mg/dl | 12.7 | 13.7 | 13.5 | 14.2 |
| Ammonia, | 139 | 119 | 151 | 136 |
| mg/dl | | | | |
| Creatinine, | 0.50 | 0.50 | 0.49 | 0.53 |
| mg/dl | | | | |
| Glucose, mg/dl | 78 | 91 | 75 | 78 |
| Sodium, mmol/l | 155 | 157 | 159 | 155 |
| Potassium, | 4.4 | 4.5 | 4.8 | 4.6 |
| mmol/l | | | | |
| Chloride, | 117 | 120 | 119 | 117 |
| mmol/l | | | | |
| Calcium, mg/dl | 10.1 | 10.4 | 10.1 | 10.0 |
| Phosphorus, | 4.0 | 4.1 | 4.1 | 3.6 |
| mg/dl | | | | |
| Magnesium, | 1.6 | 1.6 | 1.7 | 1.6 |
| mEq/l | | | | |
| Total protein, | 6.1 | 6.3 | 6.3 | 6.2 |
| g/dl | | | | |
| Albumin, g/dl | 3.6 | 3.6 | 3.5 | 3.4 |
| Globulin, g/dl | 2.5 | 2.7 | 2.8 | 2.8 |
| ALT, u/l | 48 | 59 | 50 | 61 |
| ALP, u/l | 142 | 174 | 267 | 211 |
| Total bilirubin, | 0.3 | 0.5 | 0.5 | 0.2 |
| mg/dl | | | | |

TABLE 8

| Study time | Week 12 | | | |
|---|---|---|---|---|
| Oat conc. % | 0 | 5 | 10 | 20 |
| Triglycerides, | 92 | 109 | 116 | 91 |
| mg/dl | | | | |
| Cholesterol, | 246 | 243 | 244 | 214 |
| mg/dl | | | | |
| BUN, mg/dl | 13.9 | 13.4 | 12.3 | 12.2 |
| Ammonia, | 158 | 172 | 140 | 139 |
| mg/dl | | | | |
| Creatinine, | 0.51 | 0.53 | 0.49 | 0.49 |
| mg/dl | | | | |
| Glucose, mg/dl | 66 | 74 | 76 | 77 |
| Sodium, mmol/l | 159 | 157 | 158 | 158 |
| Potassium, | 4.8 | 4.7 | 4.7 | 4.6 |
| mmol/l | | | | |
| Chloride, | 120 | 118 | 119 | 120 |
| mmol/l | | | | |
| Calcium, mg/dl | 10.5 | 10.4 | 10.2 | 10.1 |
| Phosphorus, | 4.2 | 4.0 | 4.2 | 4.0 |
| mg/dl | | | | |
| Magnesium, | 1.8 | 1.8 | 1.8 | 1.6 |
| mEq/l | | | | |
| Total protein, | 6.4 | 6.2 | 6.3 | 6.2 |
| g/dl | | | | |
| Albumin, g/dl | 3.7 | 3.6 | 3.5 | 3.5 |
| Globulin, g/dl | 2.7 | 2.7 | 2.8 | 2.8 |
| ALT, u/l | 63 | 49 | 52 | 58 |
| ALP, u/l | 151 | 158 | 276 | 219 |
| Total bilirubin, | 0.4 | 0.6 | 0.6 | 0.4 |
| mg/dl | | | | |

The results indicate that dietary oat as high as 20% does not affect blood pressure, oxidative status (plasma ORAC, glutathiones in WBC, glutathione peroxidase activities in serum and red blood cells, serum 8-OHdG and MDA), and nitrogen dynamics in healthy adult dogs. No abnormality is observed during the study. Dietary oat at 20% significantly reduces serum total cholesterol by 15%. Dietary oat at 10% also reduces serum total cholesterol but the reduction is not statistically significant.

Food intake and body weight are similar among dietary groups during the study. Fecal score is also similar among groups, demonstrating that oat groat as high as 20% does not affect fecal quality. Oat does not affect heart rate and blood pressure. (Data not shown).

Oxidative stress is measured in the dogs according to three aspects: antioxidant enzymes (red blood cell (RBC) and serum glutathione peroxidase), DNA damage (serum 8-OHdG), and fat oxidation (serum MDA). Oat has no effect on any of these measurements during the study. Similarly, oat has no effect on hematological measurements in dogs.

Serum triglyceride is not affected by dietary oat (Tables 5-8, above). This is true for other serum chemistry measurements including serum glucose. Water soluble fiber has been known to reduce postprandial blood glucose. Serum glucose in this study is measured after overnight withdrawal of food. This may explain why serum glucose is not affected by oat in this study.

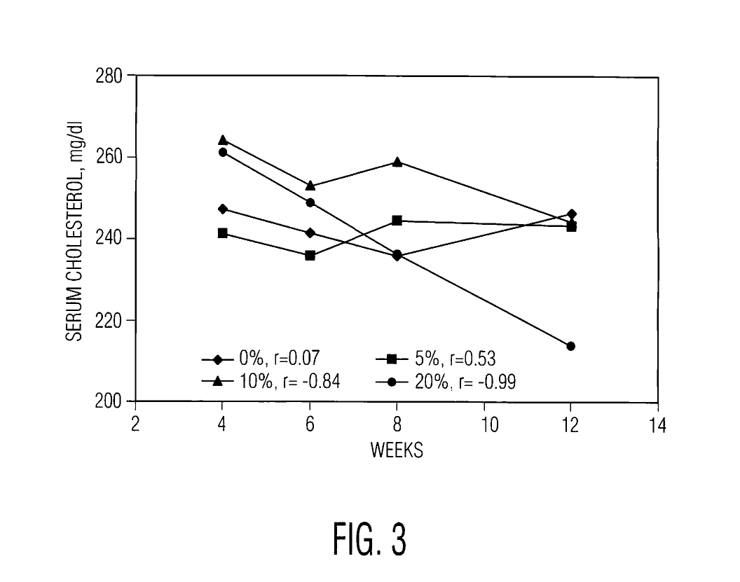

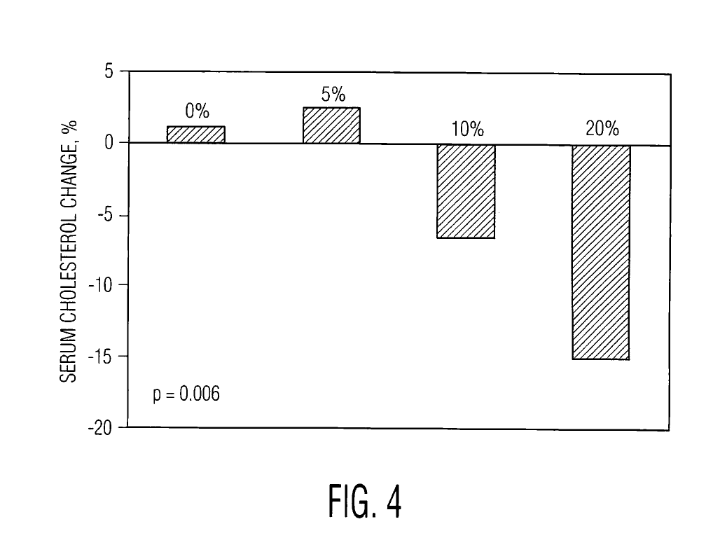

Referring to Tables 5-8 above, oat at 20% in a dry dog food significantly reduces serum total cholesterol in healthy adult dogs. Serum total cholesterol concentration declines steadily in dogs fed the diet containing 20% oat while it maintained stable in dogs fed the control food or the food containing 5% oat (FIG. 3). When comparing the initial serum cholesterol, dietary oat at 20% reduces serum total cholesterol by about 15% (p=0.019, FIG. 4). Oat at 10% also reduces serum cholesterol by about 6% but the reduction does not reach statistical significance (p=0.229, FIG. 4).

While particular embodiments of the present invention have been shown and described herein, it will be apparent to those skilled in the art that changes and modifications may be made without departing from the broader aspects of invention.

1. A method to reduce serum total cholesterol level in a companion animal in need of such reduction comprising feeding the companion animal a serum cholesterol lowering diet comprising about 20% or more oat.

2. The method of claim 1, wherein the companion animal is a cat or a dog.

3. The method of claim 1, wherein the oat is whole oat, oat bran, oat flour, rolled oat flakes, instant oat flakes, steel cut oat groats, whole oat groats, or oat starch.

4. The method of claim 1, wherein the serum cholesterol lowering diet is maintained for 6 weeks or more.

5. The method of claim 1, wherein the serum cholesterol lowering diet is maintained for 8 weeks or more.

6. The method of claim 1, wherein the serum cholesterol lowering diet is maintained for 12 weeks or more.

7. An animal food composition comprising about 20% or more oat effective to reduce the serum total cholesterol level in a companion animal in need of such reduction.

8. The animal food composition of claim 7, wherein the oat is whole oat, oat bran, oat flour, rolled oat flakes, instant oat flakes, steel cut oat groats, whole oat groats, or oat starch, or a mixture thereof.

9. The animal food composition of claim 7, wherein the companion animal is a cat or dog.

10. The animal food composition of claim 7, wherein the composition is a cat food composition or a dog food composition.
